(19) United States
(12) Patent Application Publication
(10) Pub. No.: US 2011/0128256 A1
(43) Pub. Date: Jun. 2, 2011

(54) LIGHT GUIDE APPARATUS AND OPTICAL TOUCH DISPLAY APPARATUS

(75) Inventors: Han-Wen Tsai, Hsin-Chu (TW); Ping-Feng Hwang, Hsin-Chu (TW)

(73) Assignee: CORETRONIC CORPORATION, Hsin-Chu (TW)

(21) Appl. No.: 12/881,181

(22) Filed: Sep. 14, 2010

(30) Foreign Application Priority Data
Nov. 27, 2009 (TW) 98140658

(51) Int. Cl. G06F 3/042; F21V 8/00

(52) U.S. Cl. 345/175; 362/616

(57) ABSTRACT

A light guide apparatus is adapted to a touch display apparatus. The touch display apparatus has a display area. The light guide apparatus includes a plurality of light guide units and a plurality of light sources. The light guide units are disposed beside a first side of the display area. Each of the light guide units has a light incident surface, and a space is between each two adjacent light guide units. The light sources are disposed beside the light incident surfaces of the light guide units. Each of the light sources is capable of providing a beam. The beam is capable of entering the light guide unit through the light incident surface and is capable of being transmitted to an external environment from the light guide unit. An optical touch display apparatus is also provided.

### CROSS-REFERENCE TO RELATED APPLICATION

This application claims the priority benefit of Taiwan application serial no. 98140658, filed on Nov. 27, 2009. The entirety of the above-mentioned patent application is hereby incorporated by reference herein and made a part of this specification.

### BACKGROUND OF THE INVENTION

1. Field of the Invention

The invention is related to a light guide apparatus and a touch apparatus, and in particular to a light guide apparatus adapted to a touch display apparatus and an optical touch display apparatus.

2. Description of Related Art

In recent years, with the rapid development in information technology, wireless mobile communication, and information appliances, input devices of many information products have been changed from conventional keyboards and mice into touch panels to achieve goals of convenience, light weight, and user friendliness. A touch panel is combined with a display apparatus into a touch panel display apparatus. Currently, designs of touch panels may be roughly classified into resistive, capacitive, optical, acoustic, and electromagnetic types.

In a resistive type touch panel, conductive layers originally separated become connected through a pressure of a touch, so that a voltage change occurs at a position where the connection occurs. By measuring the voltage change, coordinates of a touch position on the panel are determined. In a capacitive touch panel, electric fields are formed between different conductive patterns. When a touch object (such as a finger of a person) contacts the panel, a flow of charges is generated, thereby causing a small capacitance change. By measuring the capacitance change, coordinates of a touch position on the panel are determined.

Taiwan patent publication no. 442674 discloses a light guide unit including a protrusion having a scattering region. In addition, Taiwan patent publication no. M296382 discloses a light guide plate, wherein a light-shielding element is disposed on the light guide plate. Moreover, Taiwan patent publication no. M269471 discloses a lamp disposed inside a protrusion on a light incident surface of a light guide plate, so that a width of a non-light-emitting region of a backlight module is reduced. Taiwan patent publication no. 581849 discloses a reflecting sheet disposed between a panel and a light guide plate to shield a part of the light guide plate. Furthermore, Taiwan patent publication no. M289869 discloses a backlight module capable of preventing light leakage. A light-shielding film is adhered to a top of a light guide plate to reduce light leakage.

### SUMMARY OF THE INVENTION

The invention provides a light guide apparatus having uniform light emission intensity.

The invention provides an optical touch display apparatus having good accuracy in determining a touch position.

Other objects and advantages of the invention can be further illustrated by the technical features broadly embodied and described as follows.

An embodiment of the invention provides a light guide apparatus adapted to a touch display apparatus, wherein the touch display apparatus includes a display area. The light guide apparatus includes a plurality of light guide units and a plurality of light sources. The light guide units are disposed beside a first side of the display area. Each of the light guide units has a light incident surface, and a space is between each two adjacent light guide units. The light sources are disposed beside the light incident surfaces of the light guide units. Each of the light sources is capable of emitting a beam. The beams are capable of entering the light guide units through the light incident surfaces and being transmitted outward from the light guide units.

Furthermore, an embodiment of the invention further provides an optical touch display apparatus including a display apparatus, the above light guide apparatus, and at least one optical detector.

In summary, the embodiments of the invention have at least one of the following advantages. Since in the embodiments of the invention, segmented light guide units are capable of guiding the beam on a side of the display area, the overall light emission intensity of the light guide unit is more uniform, thereby enhancing accuracy in determining the touch position by the optical touch display apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic front view of an optical touch display apparatus according to the first embodiment of the invention.

FIG. 2 is a schematic cross-sectional view of the optical touch display apparatus in FIG. 1 along line I-I.

FIG. 3A is a schematic perspective view of a light guide unit in FIG. 1.

FIG. 3B is a schematic top view of a surface of the light guide unit and a light source in FIG. 3A along the x direction.

FIG. 4A is a schematic front view of optical detectors in FIG. 1, and a light guide unit and a light source.

FIG. 4B is a schematic distribution diagram of irradiance respectively detected by the optical detectors.

FIG. 5 is a schematic top view of the light guide unit, a protruding part, a front frame, and a reflecting unit along the x direction according to another embodiment of the invention.

FIG. 6 is a schematic front view of an optical touch display apparatus according to the second embodiment of the invention.

FIG. 7 is a schematic front view of an optical touch display apparatus according to the third embodiment of the invention.

FIG. 8 is a schematic front view of an optical touch display apparatus according to the fourth embodiment of the invention.

FIG. 9 is a schematic front view of an optical touch display apparatus according to the fifth embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

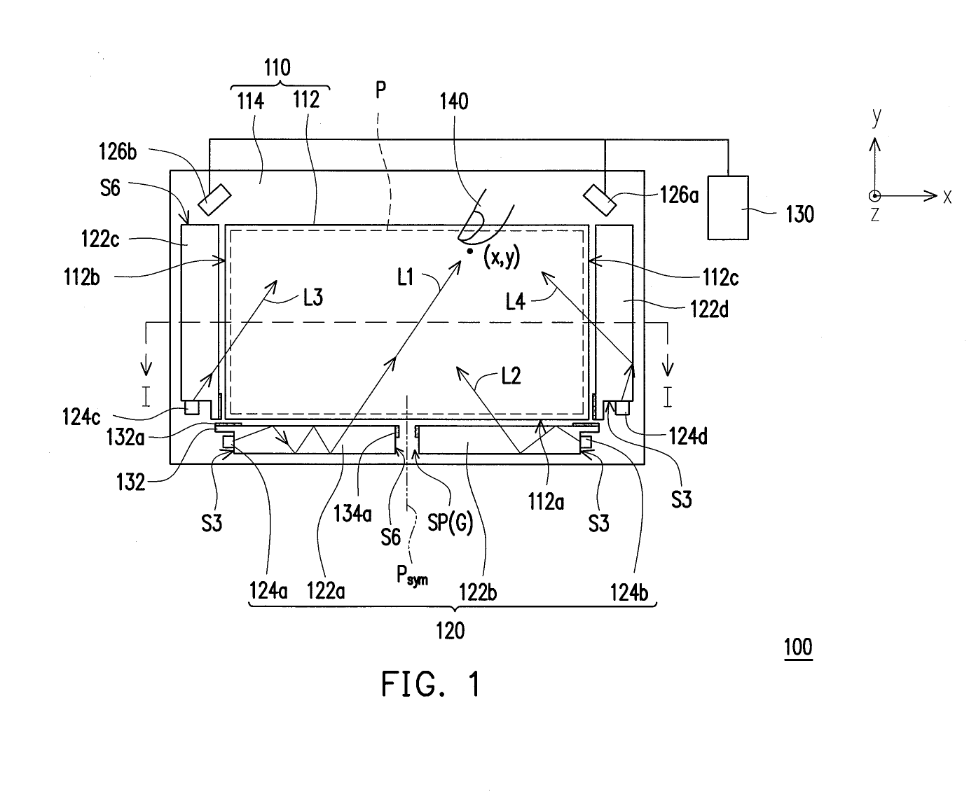

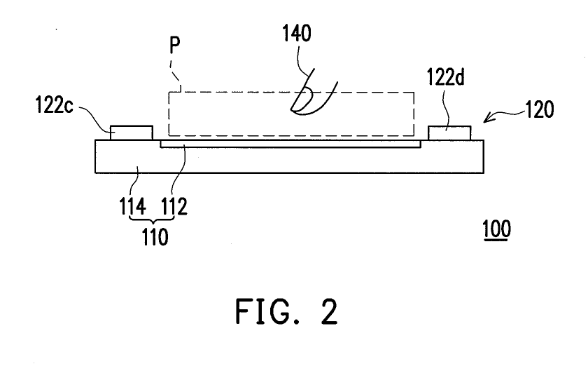

Referring to both FIGS. 1 and 2, an optical touch display apparatus 100 according to the embodiment includes a display apparatus 110, a light guide apparatus 120, and at least one optical detector 126a. The light guide apparatus 120 is adapted to the display apparatus 110, wherein the display apparatus 110 is a touch display apparatus, for example. The display apparatus 110 has a display area 112, wherein a sensing space P exists in front of the display area 112. In addition, the display apparatus 110 according to the embodiment further includes an outer frame 114. According to the embodiment, the display area 112 is disposed in the outer frame 114, and the light guide apparatus 120 is disposed on the outer frame 114.

As shown in FIG. 1, the light guide apparatus 120 includes a plurality of light guide units 122a and 122b and a plurality of light sources 124a and 124b. The light guide units 122a and 122b are disposed beside a first side 112a of the display area 112. In addition, each of the light guide units 122a and 122b has a light incident surface S3, and a space SP is disposed between each two adjacent light guide units 122a and 122b, so that the light guide units 122a and 122b may have space to expand after being heated.

On the other hand, the light sources 124a and 124b are disposed beside the light incident surfaces S3 of the light guide units 122a and 122b. According to the embodiment, the light sources 124a and 124b are, closely adhered to the light incident surfaces S3 of the light guide units 122a and 122b, respectively. Alternatively, small gaps are maintained between the light sources 124a and 124b and the light incident surfaces S3 of the light guide units 122a and 122b, respectively. The gaps are smaller than or equal to 0.5 millimeters for example, so as to enhance light usage efficiency of the light sources 124a and 124b. In addition, according to the embodiment, the optical touch display apparatus 100 further includes light guide units 122c and 122d and light sources 124c and 124d. As shown in FIG. 1, the light guide unit 122c and the light source 124c are disposed beside a second side 112b of the display area 112, and the light guide unit 122d and the light source 124d are disposed beside a third side 112c of the display area 112. The light sources 124a to 124d are capable of respectively providing beams L1 to L4. The beams L1 to L4 are capable of respectively entering the light guide units 122a to 122d through the corresponding light incident surfaces S3, and are also capable of being transmitted to the sensing space P in front of the display area 112 through the light guide units 122a to 122d respectively. The light source 124a and the light source 124d are respectively capable of providing the beams L1 and L4. According to the embodiment, the beams L1 to L4 are non-visible light, and the light sources 124a to 124d are infrared light emitting diodes (IR-LED).

Still referring to FIG. 1, the light guide unit 122a is disposed in a transmission path of the beam L1. On the other hand, the optical detector 126a is disposed beside the display area 112 and is used to detect an intensity change of a beam (such as the beam L1) in the sensing space P. Moreover, the optical touch display apparatus 100 further includes the optical detector 126b capable of detecting an intensity change of a beam (such as the beam L2 or L4) in the sensing space P. Each of the optical detectors is disposed beside the display area 112 and corresponds to at least one of the light guide units. In detail, the optical detector 126a is disposed beside the display area 112 and faces the light guide units 122a and 122c, and the optical detector 126b is disposed beside the display area 112 and faces the light guide units 122b and 122d. The optical detector 126a detects, for example, an intensity change in the x direction of the beam L1 emitted from the light guide unit 122a or an intensity change in the y direction of the beam L3 emitted from the light guide unit 122c. On the other hand, the optical detector 126b detects, for example, an intensity change in the y direction of the beam L4 emitted from the light guide unit 122d or an intensity change in the x direction of the beam L2 emitted from the light guide unit 122b.

In addition, according to the embodiment, the optical touch display apparatus 100 further includes a processing unit 130 electrically connected to the optical detectors 126a and 126b. Referring to both FIGS. 1 and 2, when a touch object 140 (such as a finger) enters the sensing space P, the processing unit 130 determines a position (x,y) of the touch object 140 relative to the display area 112 according to the respective intensity changes in the different directions of the beams emitted from the light guide units.

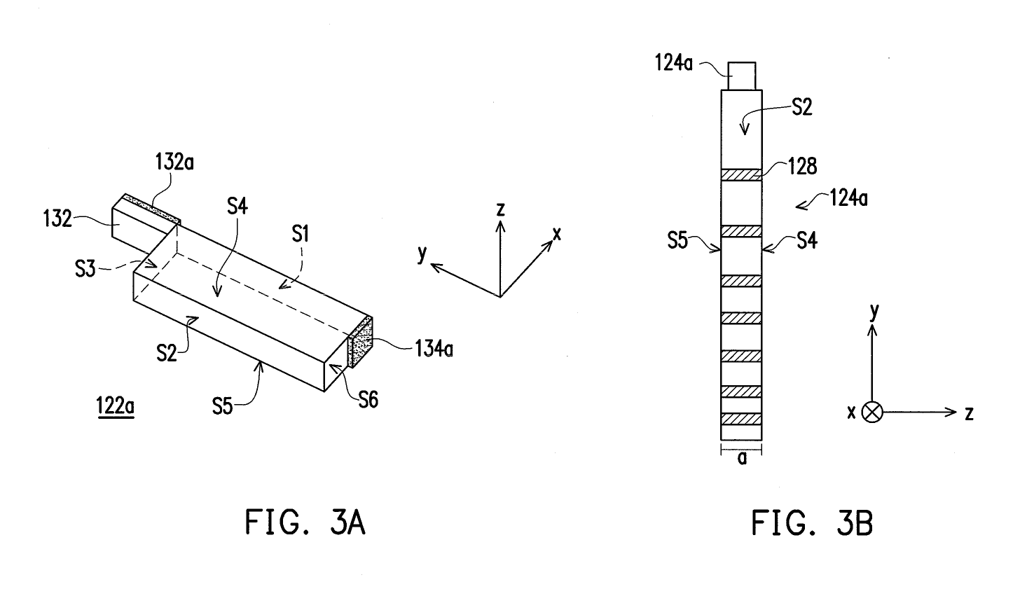

As shown in FIG. 3A, the light guide unit 122a includes a surface S1, a surface S2, and the light incident surface S3. The surface S2 is opposite to the surface S1, and the light incident surface S3 is connected to the surface S1 and the surface S2. Referring to both FIGS. 1 and 3A, the beam L1 from the light source 124a enters the light guide unit 122a through the light incident surface S3 and is transmitted to the sensing space P in front of the display area 112 through the surface S1. In other words, according to the embodiment, the surface S1 of the light guide unit 122a is a light emitting surface.

In addition, the light guide unit 122a according to the embodiment further includes a surface S4, a surface S5, and a surface S6. As shown in FIG. 3A, the surface S4 of the light guide unit 122a is connected to the light incident surface S3, the surface S1, and the surface S2. The surface S5 is opposite to the surface S4, and is connected to the light incident surface S3, the surface S1, and the surface S2. On the other hand, the surface S6 is opposite to the light incident surface S3.

As shown in FIG. 3B, the surface S2 has a plurality of microstructures 128. The number density of the microstructures 128 at a position close to the light source 124a is smaller than the number density of the microstructures 128 at a position away from the light source 124a. The microstructures 128 are, for example, printed dots or etched dots. In addition, the printed dots are, for example, protruding dots or protruding veins, and the etched dots are, for example, protruding dots or protruding veins after ejected from a mold. In the invention however, the microstructures are not limited to protruding dots or protruding veins; the microstructures may also be dented dots or dented veins and are adjustable according to requirements by the designer. By adjusting spacing between the microstructures 128 (the number density of the microstructures 128), the beam L1 in FIG. 1 is uniformly emitted from the light emitting surface (shown as the surface S1) of the light guide unit 122a, so that the light guide unit 122a provides highly uniform light in the x direction. It should be noted that, a width a of the light guide unit 122a in the z direction may be narrow, thereby facilitating reduction in thickness of the optical touch display apparatus 100.

Additionally, according to other embodiments, the microstructures 128 may also exist on the surface S4, the surface S5, and the surface S6 (shown in FIG. 3A) of the light guide unit 122a. In other words, at least one of the surface S2, the surface S4, the surface S5, and the surface S6 of the light guide unit 122a has the plurality of microstructures 128, so that the beam L1 is uniformly emitted in the x direction from the light emitting surface (the surface S1) of the light guide unit 122a. On the other hand, the light guide unit 122b in FIG. 1 may have the same structure as the structure of the light guide unit 122a, so that the beam L2 is uniformly emitted in the x direction from the light emitting surface (the surface S1) of the light guide unit 122b. Similarly, each of the light guide units 122c and 122d may also have the same structure as the structure of the light guide unit 122a, so that uniform light is provided at two other sides (the second side 112b and the third side 112c) of the display area 112, and the irradiance in the sensing space P is hence uniform. The irradiance (W/m²) is defined as incident photoenergy per unit area per unit time. The structure of each of the light guide units 122b to 122d may be referred to the light guide unit 122a and is not repeatedly described.

Referring to both FIGS. 1 and 3A, when the touch object 140 enters the sensing space P, the touch object 140 blocks a part of the beam L1 emitted from the light guide unit 122a, so that the optical detector 126a detects the intensity change in the corresponding x direction of the beam L1. In other words, the optical detector 126a detects a dark spot at the corresponding x direction. The dark spot is capable of being used as a basis for determining an x coordinate of a touch position. Similarly, the touch object 140 blocks a part of the beam L4 emitted from the light guide unit 122d, so that the optical detector 126b detects the intensity change in the y direction of the beam L4. In other words, the optical detector 126b detects a dark spot at the corresponding y direction. The dark spot is capable of being used as a basis for determining a y coordinate of the touch position. Next, the processing unit 130 determines the position (x,y) of the touch object 140 relative to the display area 112 according to the intensity changes in the above two directions. Positions of the optical detectors 126a and 126b are not limited to the positions in FIG. 1 and may be adjusted according to the requirements by the designer.

Generally, a part of the beam L1 emitted from a part of the surface S1 adjacent to the light incident surface S3 is stronger in a situation of being only the light guide unit 122a and the light source 124a, so that the beam L1 emitted from the surface S1 is non-uniform, thereby affecting the accuracy in determining the touch position by the optical touch display apparatus 100. In order to improve this condition, the light guide unit 122a in FIGS. 1 and 3A includes a protruding part 132, wherein the protruding part 132 is disposed on a part of the light incident surface S3 close to the first side 112a of the display area 112. In addition, the protruding part 132 includes a light absorbing material 132a. The light absorbing material 132a is coated on at least one portion of the protruding part 132, wherein the light absorbing material 132a is, for example, a black light absorbing material.

As shown in FIG. 1, the light guide units 122a, 122b, 122c, and 122d respectively have the protruding parts 132 coated with the light absorbing material 132a, so as to absorb a part of the beam having strong intensity and emitted from the part of the surface S1 adjacent to the light incident surface S3 (shown in FIG. 3A). Hence, overall light emission intensity of the light guide units 122a, 122b, 122c, and 122d is more uniform, so that the accuracy in determining the touch position by the optical touch display apparatus 100 is enhanced. On the other hand, in order to solve the problem that a part of the beam L1 emitted from a part of the surface S1 adjacent to the surface S6 is stronger, as shown in FIG. 3A, the light absorbing material 134a is further coated on at least one part of the surface S6. In detail, the light absorbing material 134a is coated at a position on the surface S6 close to the surface S1, so as to absorb the part of the beam L1 emitted from the part of the surface S1 adjacent to the surface S6. As such, the overall light emission intensity of the light guide unit 122a is more uniform, so that the accuracy in determining the touch position is further enhanced. Similarly, the light absorbing material 134a is also coated on at least one part of the surface S6 of the light guide unit 122b, so that the beam L2 emitted from the light guide unit 122b is more uniform.

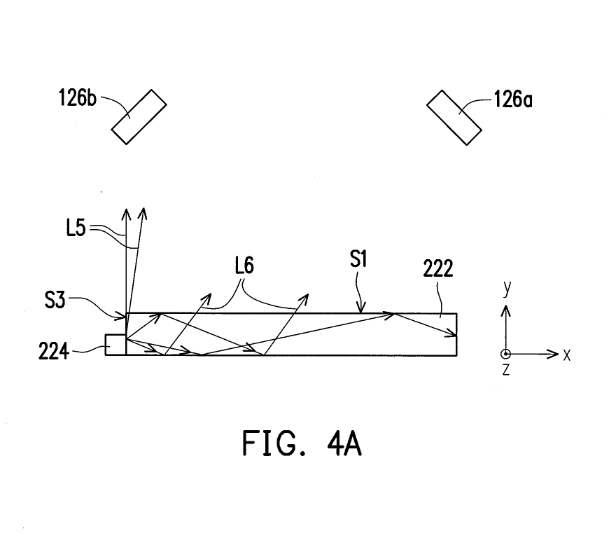

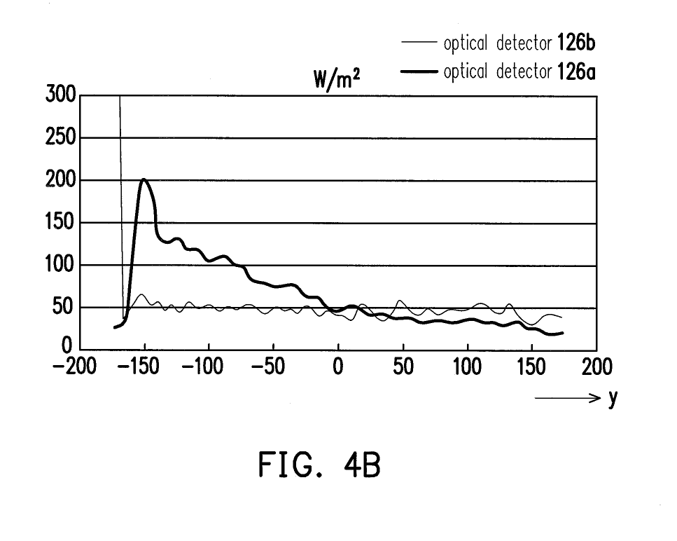

Referring to FIG. 4A and FIG. 4B, a schematic distribution diagram of the irradiance respectively detected by the optical detectors 126a and 126b is shown when the light guide unit 222 and the light source 224 in FIG. 4A are disposed beside the first side 112a of the display area 112 in FIG. 1, wherein the horizontal axis corresponds to a position on the light guide unit 222 in the y direction, and the vertical axis corresponds to the irradiance (W/m²). In detail, a coordinate 0 corresponds to a center position on the light guide unit 222, and coordinates −200 and 200 respectively correspond to two ends of the light guide unit 222.

Referring to both FIGS. 4A and 4B, since the light source 224 generates the leakage beam L5 at the part of the surface S1 of the light guide unit 222 close to the light incident surface S3, the optical detector 126b located at the same side as the light source 224 detects a stronger beam intensity at the position close the light incident surface S3 (corresponding to about −220 on the horizontal axis) than the beam intensity at other positions. On the other hand, since the beam L6 emitted from the part of the surface S1 adjacent to the light incident surface S3 has a stronger intensity, and since the beams L6 emitted from the surface S1 are substantially transmitted towards the same direction as shown in FIG. 4A, the optical detector 126a located at a side different from the side of the light source 224 detects a stronger beam intensity at the position close the light incident surface S3 (corresponding to a value smaller than 0 on the horizontal axis) than the beam intensity at other positions. The intensity of the beam emitted from the surface S1 of the light source 224 varies along different positions on the light guide unit 222, so that the overall light emission intensity of the light guide unit 222 is non-uniform, thereby reducing the accuracy in determining the touch position by the optical detectors 126a and 126b.

As shown in FIG. 1, the light guide units 122a to 122d and the light sources 124a to 124d are at least one pair of light guide units (the light guide units 122a and 122b) and at least one pair of light sources (the light sources 124a and 124b). The pair of light guide units and the pair of light sources are in mirror symmetry across a symmetry plane P_{sym}, and a space SP is a gap G along the symmetry plane P_{sym}. In addition, the light sources 124a and 124b are respectively disposed beside the two sides of the light guide units 122a and 122b away from the symmetry plane P_{sym}. As shown in FIG. 1, by disposing at least one pair of light guide units beside the first side 112a of the display area 112 and the two light sources 124a and 124b corresponding to the pair of light guide units, the beams L1 and L2 have transmission paths that are in mirror symmetry, so that the optical detectors 126a and 126b at two sides detect uniform beam intensity.

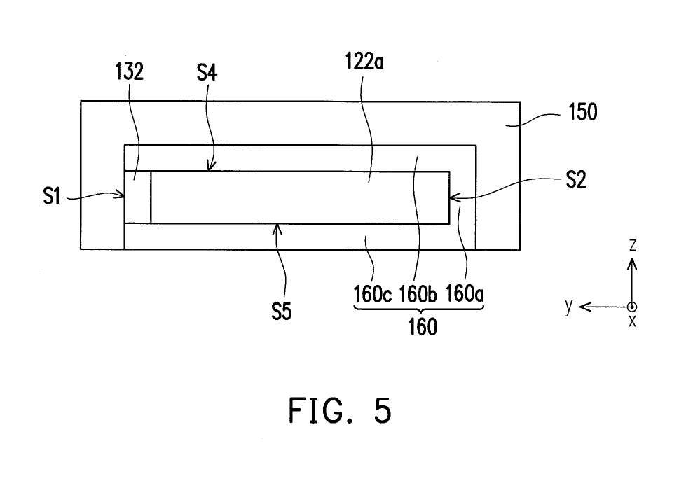

As shown in FIG. 5, a reflecting unit 160 is further disposed on the light guide unit 122a, wherein the reflecting unit 160 is disposed on at least one of the surface S2, the surface S4, and the surface S5, so as to reduce a chance of the beam L1 (shown in FIG. 1) leaking from the surface S2, the surface S4, and the surface S5.

According to the embodiment, the reflecting unit 160 includes, for example, reflecting sheets 160a, 160b, and 160c respectively disposed on the surface S2, the surface S4, and the surface S5. According to other embodiments, the reflecting unit 160 may be disposed on the surface S6 (shown in FIG. 1) of the light guide unit 122a. In other words, the reflecting unit 160 is disposed on at least one of the surface S2, the surface S4, the surface S5, and the surface S6. Except the light incident surface S3 and the light emitting surface (the surface S1) of the light guide unit 122a, the other surfaces may be covered by the reflecting unit 160. The reflecting unit 160 is, for example, a white reflecting sheet, an aluminum reflecting sheet, an aluminum film, or a silver film. Similarly, according to other embodiments, the reflecting unit 160 may be disposed on a part of the surfaces of the light guide units 122b to 122d.

Additionally, a front frame 150 according to the embodiment covers a part of the surfaces of the light guide unit 122a. According to the embodiment, the front frame 150 covers, for example, the surface S1, the surface S2, the surface S4, and the surface S6. However, according to other embodiments, the front frame 150 may cover one of the light incident surface S3, the surface S1, the surface S2, the surface S4, and the surface S6. The front frame 150 is configured to let the beam L1 pass. A color master may be added in the front frame 150, so that the front frame 150 is opaque, and the optical touch display apparatus 100 is thereby better-looking. Since infrared light is capable of passing through the color master, in other words, the beam L1 is capable of passing through the front frame 150 and reach the sensing space P in FIG. 1, detecting functions of the optical detectors 126a and 126b are not affected.

### Second Embodiment

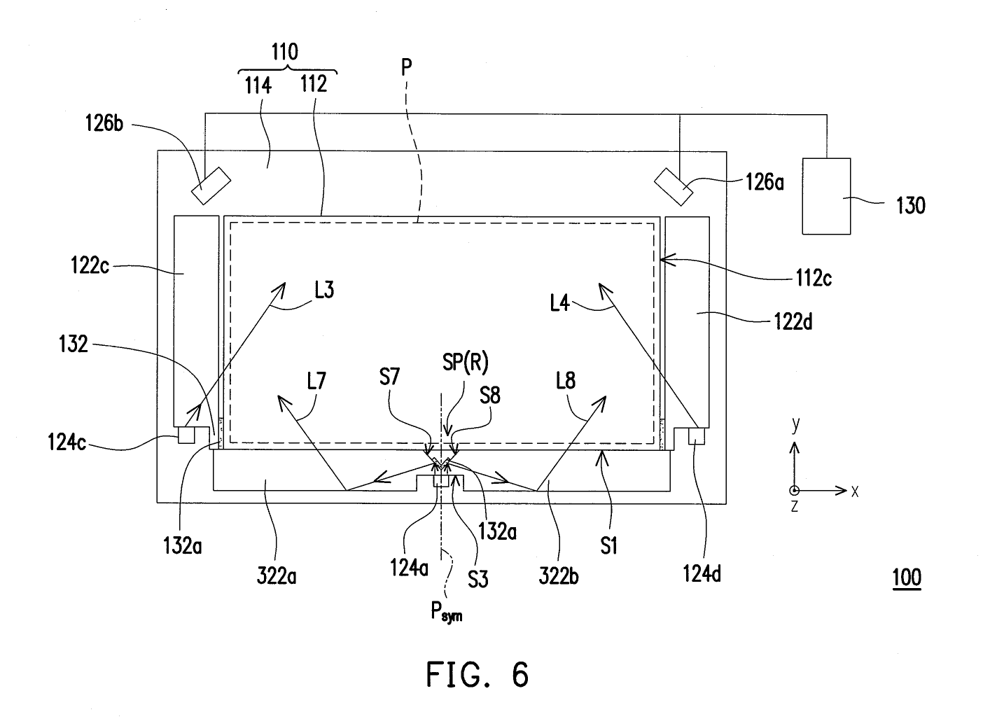

Referring to FIG. 6, the optical touch display apparatus 200 according to the embodiment is similar to the optical touch display apparatus 100. The difference in between is that the space SP in FIG. 1 is defined by a dent R at the symmetry plane P_{sym} of FIG. 6, and light guide units 322a and 322b are connected to each other or are formed as an integrated unit, wherein the dent R is located on a side of a junction, and the light guide units 322a and 322b are connected through the junction.

As shown in FIG. 6, the dent R is dented towards the light incident surfaces S3 of the light guide units 322a and 322b, wherein at least one light source (the light source 124a) of the light sources 124a and 124b is disposed beside the light incident surfaces S3 of the light guide units 322a and 322b. The light guide units 322a and 322b according to the embodiment further includes two reflecting surfaces S7 and S8. As shown in FIG. 6, the reflecting surfaces S7 and S8 are disposed at a position where the light guide units 322a and 322b adjoin the dent R. An air gap, for example, is included between the dent R and the display area, so that when beams L7 and L8 emitted from the light source 124a are respectively transmitted to the reflecting surfaces S7 and S8, the beams L7 and L8 are totally reflected by the surfaces S7 and S8 to be transmitted inside the light guide units 322a and 322b. When the beams L7 and L8 are emitted from the surface S1 to the sensing space P, transmission paths of the beams L7 and L8 are in mirror symmetry, so that the optical detectors 126a and 126b at the two sides detect uniform beam intensity.

Moreover, in order to avoid light leakage generated by the light source 124a on the reflecting surfaces S7 and S8, according to the embodiment, the reflecting surfaces S7 and S8 of the light guide unit are further coated with the light absorbing material 132a. The light absorbing material 132a is coated on at least one part of the reflecting surfaces S7 and S8. For example, the light absorbing material 132a is coated at the junction between the reflecting surfaces S7 and S8.

### Third Embodiment

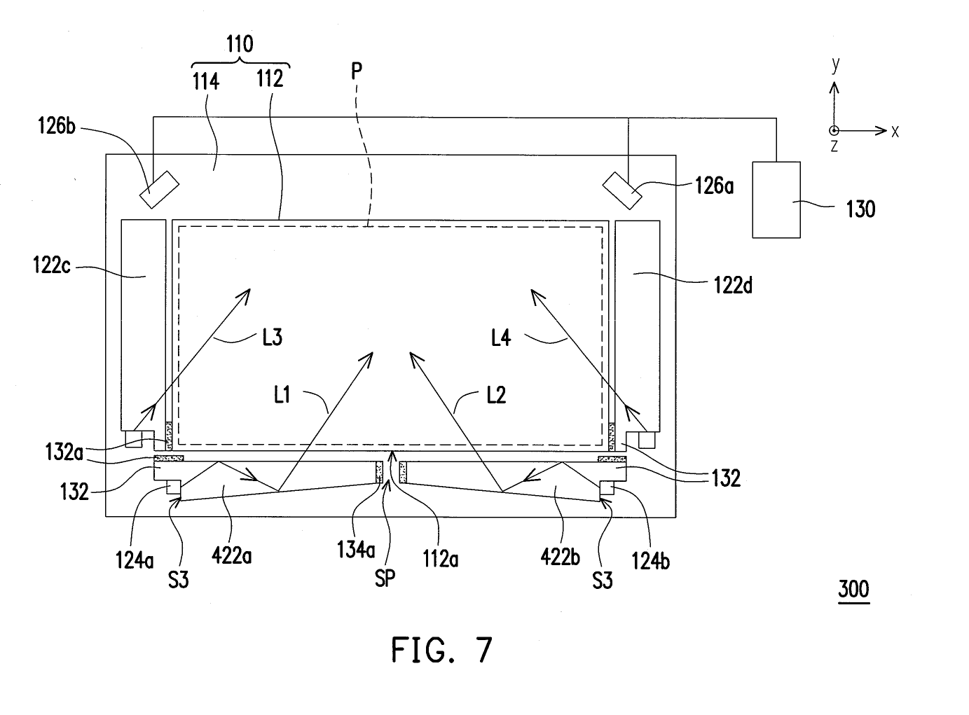

Referring to FIG. 7, the optical touch display apparatus 300 according to the embodiment is similar to the optical touch display apparatus 100. The main difference in between is that a shape of light guide units 422a and 422b is different from a shape of the light guide units 122a and 122b in FIG. 1. In detail, the shape of the light guide units 422a and 422b is more similar to a wedge. The shape of the light guide units 422a and 422b may be designed according to actual requirements and is not limited to the above. As same as the first embodiment, by disposing a type of segmented light guide units as the light guide units 422a and 422b beside the first side 112a of the display area 112, the beams L1 and L2 also generate uniform light intensity on the first side 112a.

### Fourth Embodiment

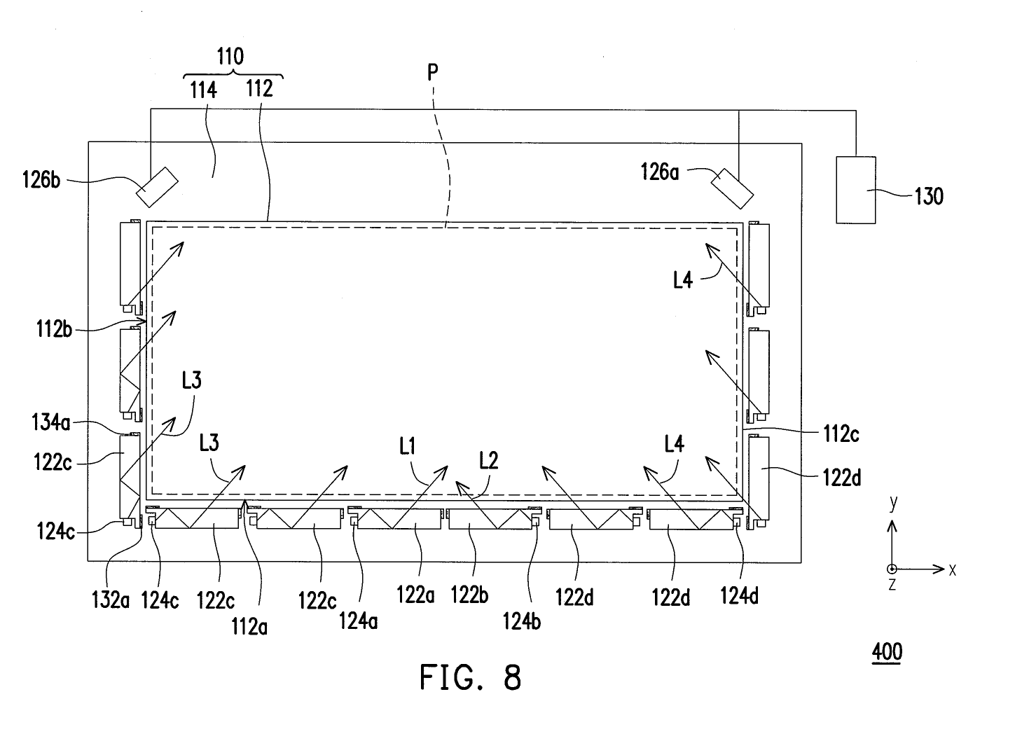

Referring to FIG. 8, the optical touch display apparatus 400 according to the embodiment is similar to the optical touch display apparatus 100. The main difference in between is that the optical touch display apparatus 400 is adapted to a large display apparatus.

In detail, as shown in FIG. 8, in addition to having at least one pair of light guide units (the light guide units 122a and 122b) and at least one pair of light sources (the light sources 124a and 124b) beside the first side 112a of the display area 112 of the optical touch display apparatus 400, the optical touch display apparatus 400 further includes a plurality of light guide units 122c and 122d (only two are schematically drawn) and a plurality of light sources 124c and 124d (only two are schematically drawn). Descriptions of the light guide units 122c and 122d and the light sources 124c and 124d may be referred to the first embodiment and are not repeatedly described. On the other hand, a plurality of light guide units 122c (only three are schematically drawn) and a plurality of light guide units 122d (only three are schematically drawn) are respectively disposed beside the second side 112b and the third side 112c of the display area 112. Through the same principle used in the first embodiment, by disposing the light guide units around a periphery of the display area in a segmented manner, the intensity of the beams L1 to L4 are distributed more uniformly in the sensing space P, thereby enhancing the accuracy in detection by the optical detectors 126a and 126b.

### Fifth Embodiment

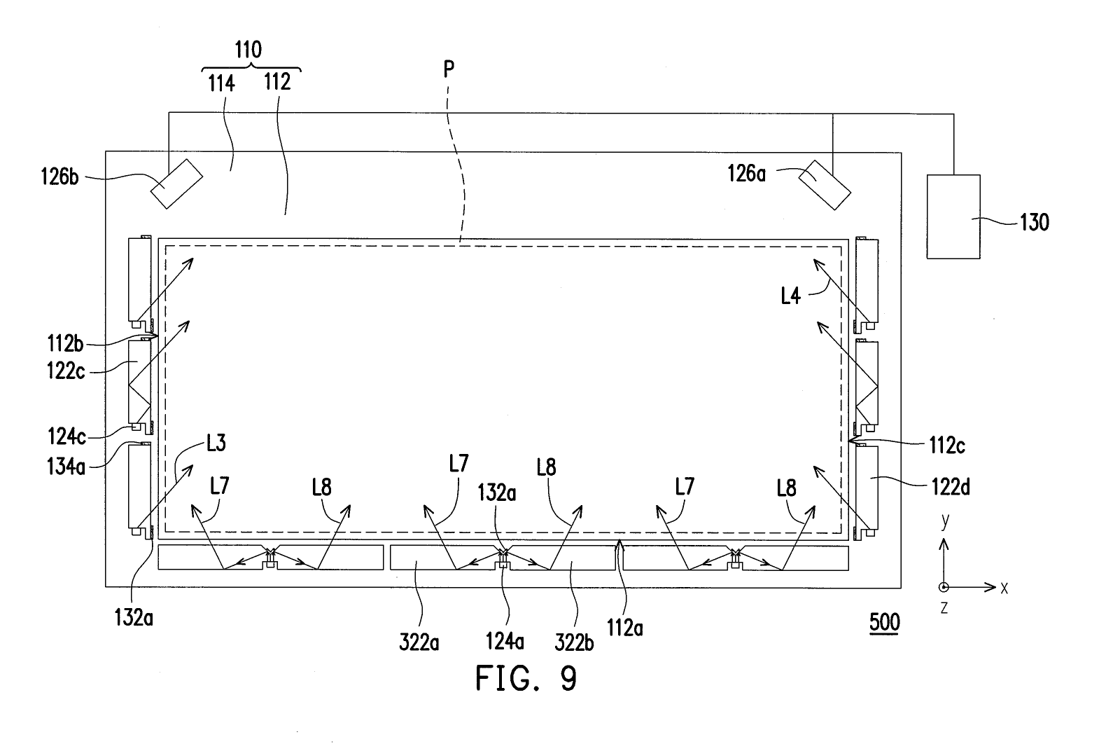

Referring to FIG. 9, the optical touch display apparatus 500 according to the embodiment is similar to the optical touch display apparatus 400. The main difference in between is that there are three pairs of the light guide units (the light guide units 322a and 322b) and three light sources 124a beside the first side 112a of the display area 112 of the optical touch display apparatus 500, wherein the descriptions of the light guide units 322a and 322b may be referred to the fourth embodiment and is not repeatedly described. The number of pairs of the light guide units may be designed according to actual requirements and are not limited to the above. Through the same principle as in the first embodiment and by adopting the above arrangement, the intensity of beams L3, L4, L7, and L8 are distributed more uniformly in the sensing space P, thereby enhancing the accuracy in detection by the optical detectors 126a and 126b.

In summary, the embodiments of the invention have at least one of the following advantages. Since the segmented light guide units are capable of guiding the beams on a side of the display area, the overall light emission intensity of the light guide units are more uniform, thereby enhancing the accuracy in determining the touch position by the optical touch display apparatus. In addition, by using the light absorbing material coated on the protruding part to absorb the part of the beam that is too strong and emitted from the part of the first surface adjacent to the light incident surface, the overall light emission intensity of the light guide unit is also more uniformed.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide apparatus, adapted to a touch display apparatus comprising a display area, the light guide apparatus comprising:
a plurality of light guide units, disposed beside a first side of the display area, each of the light guide units comprising a light incident surface, and a space disposed between each two of the light guide units; and
a plurality of light sources, disposed beside the light incident surfaces of the light guide units, each of the light sources being capable of providing a beam, the beam being capable of entering the light guide unit through the light incident surface and being capable of being transmitted outward from the light guide unit.

2. The light guide apparatus of claim 1, wherein the light guide units and the light sources comprise at least one pair of light guide units and at least one pair of light sources, the pair of light guide units and the pair of light sources are in mirror symmetry across a symmetry plane, and the space is a gap along the symmetry plane.

3. The light guide apparatus of claim 1, wherein the light guide units comprise at least one pair of light guide units, the pair of light guide units are in mirror symmetry across a symmetry plane, and the space is defined by a dent at the symmetry plane, the dent is dented towards the light incident surfaces of the light guide units, and at least one of the light sources is disposed beside at least one of the light incident surfaces of the light guide units.

4. The light guide apparatus of claim 3, wherein the pair of light guide units are connected to each other, and the dent is disposed on a side of a junction through which the pair of light guide units are connected.

5. The light guide apparatus of claim 4, wherein the pair of light guide units further comprise two reflecting surfaces disposed at a position where the pair of light guide units adjoin the dent.

6. The light guide apparatus of claim 1, wherein each of the light guide units comprises a protruding part disposed on a part of the light incident surface adjacent to the first side of the display area.

7. The light guide apparatus of claim 6, wherein the protruding part comprises a light absorbing material coated on at least one part of the protruding part.

8. The light guide apparatus of claim 1, further comprising a light absorbing material coated on at least one part of surfaces of the light guide units.

9. The light guide apparatus of claim 8, wherein the light guide unit further comprises a first surface opposite to the light incident surface, and the light absorbing material is coated on at least one part of the first surface.

10. The light guide apparatus of claim 1, further comprising a reflecting unit disposed on at least one part of surfaces of the light guide units.

11. An optical touch display apparatus, comprising:
a display apparatus, comprising a display area;
a light guide apparatus, the light guide apparatus comprising:
a plurality of light guide units, disposed beside a first side of the display area, each of the light guide units comprising a light incident surface, and a space being disposed between each two of the light guide units; and
a plurality of light sources, disposed beside the light incident surfaces of the light guide units, each of the light sources being capable of providing a beam, the beam being capable of entering the light guide unit through the light incident surface and being capable of being transmitted to a sensing space in front of the display area from the light guide unit; and
at least one optical detector, disposed beside the display area and used to detect an intensity change of the beam in the sensing space.

12. The optical touch display apparatus of claim 11, wherein the light guide units and the light sources comprise at least one pair of light guide units and at least one pair of light sources, the pair of light guide units and the pair of light sources are in mirror symmetry across a symmetry plane, and the space is a gap along the symmetry plane.

13. The optical touch display apparatus of claim 11, wherein the light guide units comprise at least one pair of light guide units, the pair of light guide units are in mirror symmetry across a symmetry plane, and the space is defined by a dent at the symmetry plane, the dent is dented towards the light incident surfaces of the light guide units, and at least one of the light sources is disposed beside at least one of the light incident surfaces of the light guide units.

14. The optical touch display apparatus of claim 13, wherein the pair of light guide units are connected to each other, and the dent is disposed on a side of a junction through which the pair of light guide units are connected.

15. The optical touch display apparatus of claim 14, wherein the pair of light guide units further comprise two reflecting surfaces disposed at a position where the pair of light guide units adjoin the dent.

16. The optical touch display apparatus of claim 11, wherein each of the light guide units comprises a protruding part disposed on a part of the light incident surface adjacent to the first side of the display area.

17. The optical touch display apparatus of claim 16, wherein the protruding part has a light absorbing material coated on at least one part of the protruding part.

18. The optical touch display apparatus of claim 11, further comprising a light absorbing material coated on at least one part of surfaces of the light guide units.

19. The optical touch display apparatus of claim 18, wherein the light guide unit further comprises a first surface opposite to the light incident surface, and the light absorbing material is coated on at least one part of the first surface.

20. The optical touch display apparatus of claim 11, further comprising a reflecting unit disposed on at least one part of surfaces of the light guide units
